(19) United States
(12) Patent Application Publication
(10) Pub. No.: US 2025/0313160 A1
(43) Pub. Date: Oct. 9, 2025

(54) Accessory Attachment

(71) Applicant: Bombardier Recreational Products, Inc., Valcourt (CA)

(72) Inventors: Laurent SAVARD, Granby (CA); Louis-Charles GINGRAS, Rougemont (CA); Doumik COTNOIR, Sherbrooke (CA); Hugues BEAUPRE, Drummondville (CA); Kevin POIRIER, Quebec (CA)

(21) Appl. No.: 19/040,635

(22) Filed: Jan. 29, 2025

Related U.S. Application Data
(60) Provisional application No. 63/626,338, filed on Jan. 29, 2024.

(51) Int. Cl. B60R 11/00

(52) U.S. Cl. CPC B60R 11/00; B60R 2011/0059

(57) ABSTRACT

An exemplary anchor attachment device may comprise a body having a top surface interconnecting a pair of legs and a cavity within the body. An exemplary body may have an opening through a thickness between the top surface and the cavity and also have a passage between the pair of legs and through the cavity. An exemplary anchor attachment device may comprise a u-shaped jaw rotatably coupled to the body within the cavity such that the jaw comprises an arm on either side of a lock having at least one tooth structure descending away from the arm of the jaw.

### RELATED APPLICATION INFORMATION

This application claims the benefit of priority of U.S. Provisional Patent Application Ser. No. 63/626,338, filed on Jan. 29, 2024, the entire disclosures of which are incorporated herein by reference in their entirety.

### FIELD OF THE INVENTION

The present invention relates to improvements in accessory attachments placed on objects, in particular, the bodies of vehicles designed to traverse rough and/or uneven terrain, such as snowmobiles, ATVs, personal watercraft, and the like.

### BACKGROUND

Recreational vehicles often carry miscellaneous accessories for personal items, fuel, equipment, and the like, in addition to passengers. The vehicles may be provided with sections or racks and the like to carry cargo. Other sections or arrangements may be also provided to add passengers. The cargo items are often secured to parts of the vehicles by ropes, cords, tie-downs and the like. U.S. Pat. No. 9,751,592 discloses an anchor fixture for vehicle accessories.

However, the anchor fixture of U.S. Pat. No. 9,751,592 uses an anchor and base combination that relies on the base being fixed in its installed position on the attachment surface of the recreational vehicle. Once installed, the base obstructed the otherwise flat attachment surface of the vehicle when not in use. Alternatively, the base created irregularities in the attachment surface of the vehicle that increased the difficulty in storing and/or handling other items to be received in or on the vehicle that did not require use the anchor fixture.

### SUMMARY

An exemplary anchor attachment device may comprise a body having a top surface interconnecting a pair of legs and a cavity located therein. An exemplary anchor attachment body may have an opening through its thickness, that is, between the top surface and the cavity, and also have a passage between the pair of legs and through the cavity. Accordingly, an exemplary passage may be substantially orthogonal to the opening. An exemplary anchor attachment device may also have a u-shaped jaw rotatably coupled to the body within the cavity, such that the jaw comprises an arm on either side of a lock having at least one tooth structure descending away from the arm of the jaw.

In addition to the previously described embodiment, an exemplary anchor attachment device may further comprise a mouth formed in the body within which the lock may radially displace outside of the body.

In addition to the previously described embodiment and/or as an alternative to any other described exemplary embodiment, an exemplary anchor attachment device may further comprise a latch extending upwardly from the lock.

In addition to the previously described embodiment and/or as an alternative to any other described exemplary embodiment, an exemplary anchor attachment device may be further configured such that the latch and the lock are configured to radially displace within a mouth formed in the body.

In addition to the previously described embodiment and/or as an alternative to any other described exemplary embodiment, an exemplary anchor attachment device may further comprise a rail extending from each of the pair of legs below each arm of the jaw.

In addition to the previously described embodiment and/or as an alternative to any other described exemplary embodiment, an exemplary anchor attachment device may be further configured such that the opening has a polygonal shape.

In addition to the previously described embodiment and/or as an alternative to any other described exemplary embodiment, an exemplary anchor attachment device may be further configured such that the polygonal shape is hexagonal.

In addition to the previously described embodiment and/or as an alternative to any other described exemplary embodiment, an exemplary anchor attachment device may further comprise a rail extending perpendicularly away from each of the pair of legs.

In addition to the previously described embodiment and/or as an alternative to any other described exemplary embodiment, an exemplary anchor attachment device may be further configured such that each arm of the jaw is substantially parallel to each rail above which it is located.

In addition to the previously described embodiment and/or as an alternative to any other described exemplary embodiment, an exemplary anchor attachment device may further comprise a separable mount located within the cavity of the body.

In addition to the previously described embodiment and/or as an alternative to any other described exemplary embodiment, an exemplary anchor attachment device may further comprise a rail extending from each of the pair of legs below each arm of the jaw and in sliding connection with a portion of the separable mount.

In addition to the previously described embodiment and/or as an alternative to any other described exemplary embodiment, an exemplary anchor attachment device may be further configured such that the jaw is radially deflected away from the separable mount.

In addition to the previously described embodiment and/or as an alternative to any other described exemplary embodiment, an exemplary anchor attachment device may further comprise a latch extending upwardly from the lock.

In addition to the previously described embodiment and/or as an alternative to any other described exemplary embodiment, an exemplary anchor attachment device may be further configured such that the latch and the lock are configured to radially displace within a mouth formed in the body.

In addition to the previously described embodiment and/or as an alternative to any other described exemplary embodiment, an exemplary anchor attachment device may be further configured such that the latch and the lock are radially deflected away from the separable mount into the mouth.

In addition to the previously described embodiment and/or as an alternative to any other described exemplary embodiment, an exemplary anchor attachment device may be further configured such that the opening is located above the separable mount.

In addition to the previously described embodiment and/or as an alternative to any other described exemplary embodiment, an exemplary anchor attachment device may further comprise an anchor coupled to the body and the mount via the opening.

In addition to the previously described embodiment and/or as an alternative to any other described exemplary embodiment, an exemplary anchor attachment device may be further configured such that the mount is coupled to a vehicle.

In addition to the previously described embodiment and/or as an alternative to any other described exemplary embodiment, an exemplary anchor attachment may be part of an exemplary anchor attachment system comprised of a body having a top surface interconnecting a pair of legs and a cavity therein. According to this exemplary system, the body may have an opening through a thickness between the top surface and the cavity and a passage between the pair of legs and through the cavity. An exemplary passage may be substantially orthogonal to the opening. The exemplary pair of legs may rotatably couple a u-shaped jaw to the body within the cavity. An exemplary jaw may comprise an arm on either side of a lock. An exemplary lock may comprise at least one tooth structure. Furthermore, an exemplary anchor attachment system may also comprise a separable mount that is configured to engage the body and be rigidly coupled to the body via the at least one tooth of the lock.

In addition to the previously described embodiment and/or as an alternative to any other described exemplary embodiment, an exemplary anchor attachment device and/or system may further comprise a vehicle to which the separable mount is coupled.

In addition to the previously described embodiment and/or as an alternative to any other described exemplary embodiment, an exemplary anchor attachment device and/or system may be configured such that the opening has a shape configured to outwardly bias a pivot of the jaw with respect to the body.

### DESCRIPTION OF THE DRAWINGS

FIG. 1 illustrates an exemplary base and mount in accordance with an aspect of the disclosed inventions herein.

FIG. 1A illustrates an exemplary base being oriented with respect to an exemplary mount coupled to an attachment surface in accordance with another aspect of the disclosed inventions herein.

FIG. 1B illustrates an exemplary jaw of an exemplary base in accordance with another aspect of the disclosed inventions herein.

FIG. 1C illustrates another exemplary jaw of an exemplary base in accordance with a further embodiment of the disclosed inventions herein.

FIG. 1D illustrates a top sectioned view of an exemplary base and mount in accordance with the embodiment depicted in FIG. 1C.

FIG. 1E illustrates an exemplary base and mount in accordance with another embodiment of the disclosed inventions herein.

FIG. 2 illustrates an exemplary sectional view of an exemplary sliding engagement step between an exemplary base and an exemplary mount in accordance with an aspect of the disclosed inventions herein.

FIG. 3 illustrates an exemplary sectional view of an exemplary covering step between an exemplary base and an exemplary mount in accordance with an aspect of the disclosed inventions herein.

FIG. 4 illustrates an exemplary sectional view of an exemplary locking step between an exemplary base and an exemplary mount in accordance with an aspect of the disclosed inventions herein.

FIG. 4A illustrates an exemplary sectional view of an exemplary locking step between an exemplary base and an exemplary mount in accordance with a further embodiment of the disclosed inventions herein.

FIG. 5 illustrates a bottom side view of another exemplary base and mount in accordance with an aspect of the disclosed inventions herein.

FIG. 6 illustrates an exemplary two-step sectional view of a base mounted on an attachment surface of a vehicle and of a base engaged to the base in accordance with an aspect of the disclosed inventions herein.

FIG. 7 illustrates another exemplary sectional view of an exemplary base locked to an exemplary mount in accordance with yet another aspect of the disclosed inventions herein.

In the drawings like characters of reference indicate corresponding parts in the different and interchangeable and interrelated figures. Parts and components of each figure may be substitutes for other components in other figures to achieve the various methods and embodiments disclosed herein. Methods and protocols disclosed in any embodiment may be run in any order so as to affect their disclosed goals and/or enable performance of the systems as described. Additionally, any one embodiment may utilize any method or protocol described and in any portions, sequences, and combinations thereof.

### DETAILED DESCRIPTION

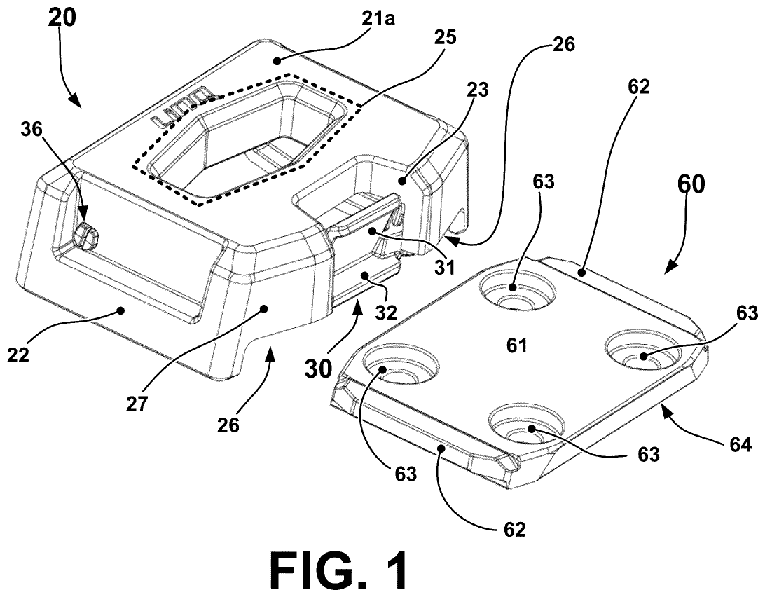

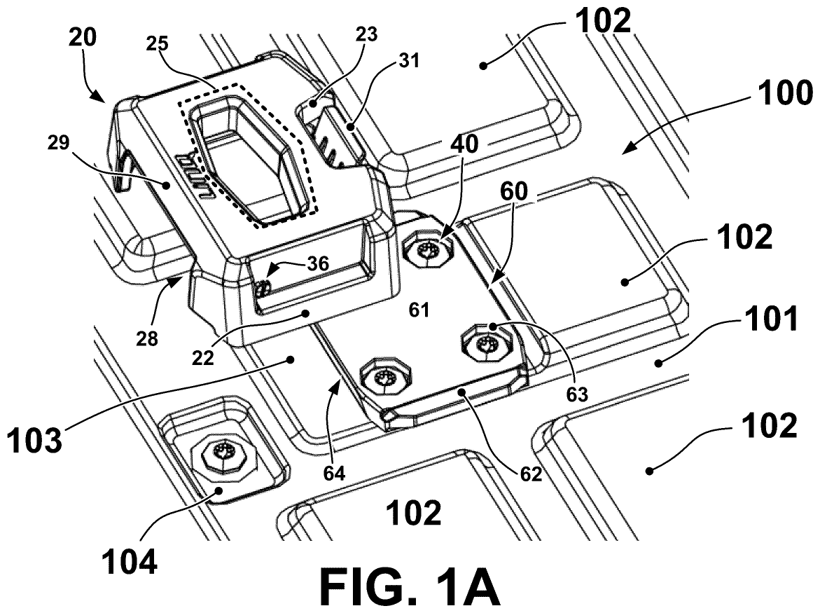

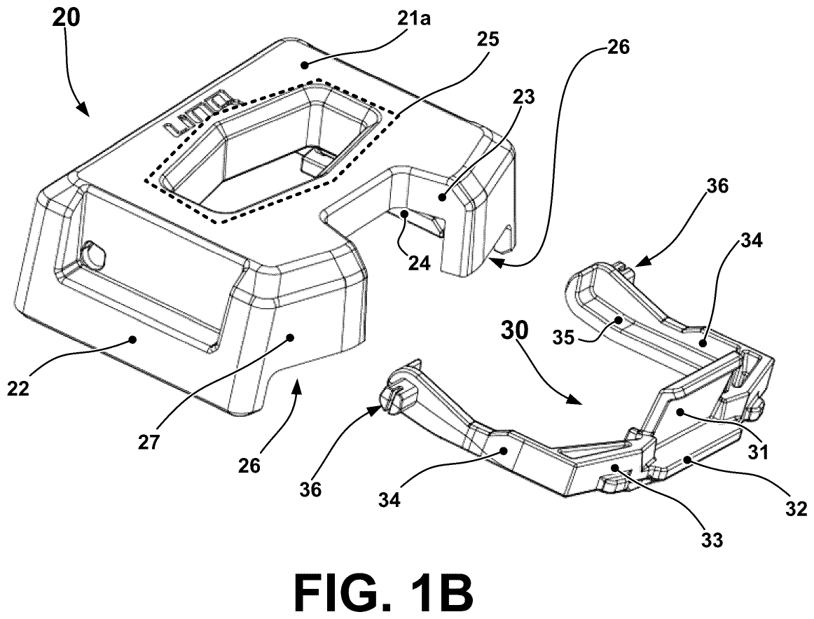

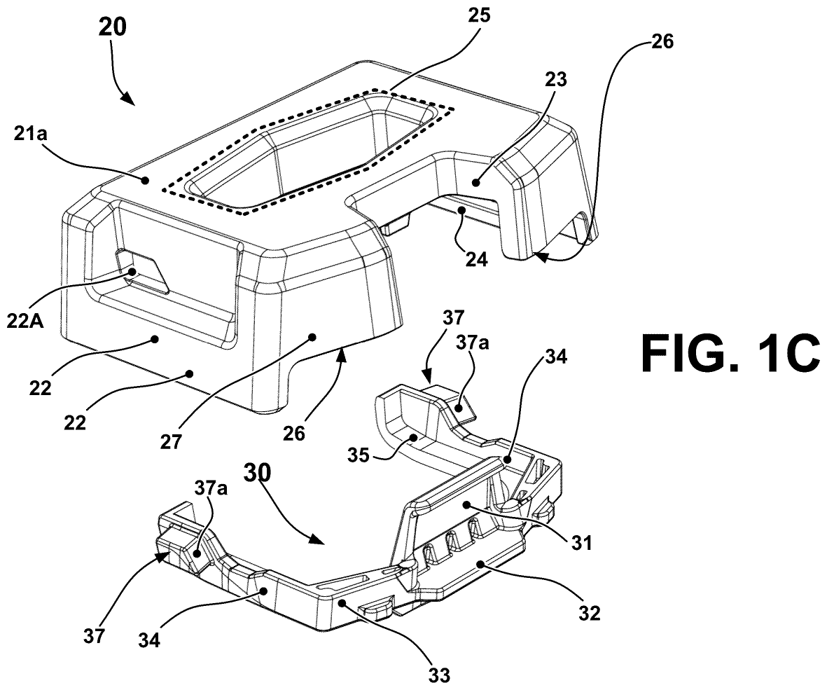

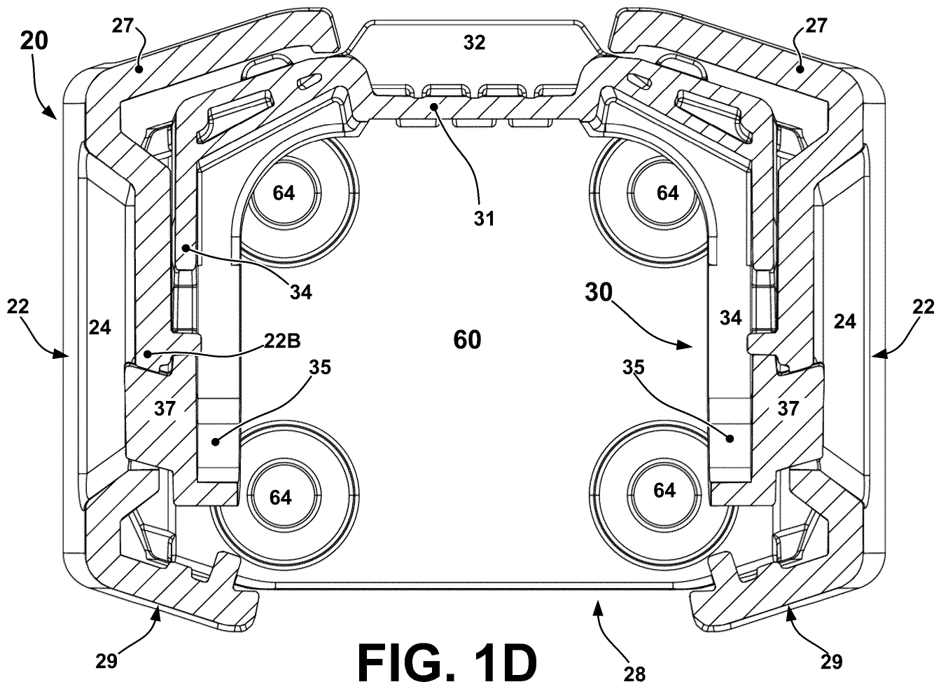

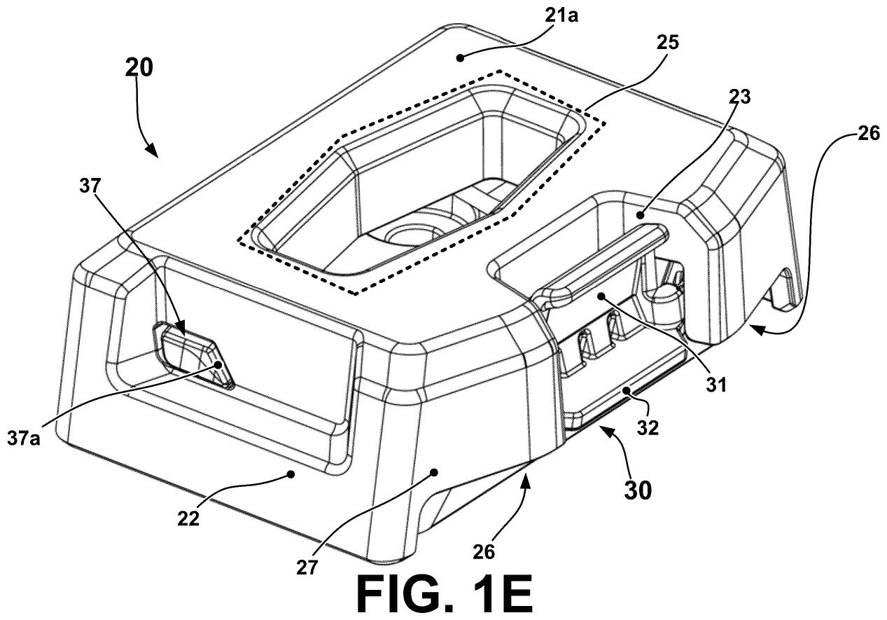

Referring to FIGS. 1 and 1A-B, an exemplary base 20 may comprise a top surface 21a, an engagement face 27, legs 22, a rear face 29, a mouth 23, front passage 26 and a rear passage 28. Through surface 21a, an exemplary base 20 may provide an exemplary fixture opening 25 for receipt of a corresponding latch of an appropriate anchor (not shown), such as, for example, the anchors and/or anchoring fixtures disclosed in U.S. Pat. Nos. 9,511,704, 9,751,592, 10,787,216, 11,286,015, 11,427,283, 11,267,407, 11,377,177, the anchor/anchor fixture disclosures of which being incorporated herein by reference in their entirety. In a preferred embodiment, opening 25 may be made for the Linq® system manufactured and sold by Bombardier Recreational Products, Inc. of Valcourt, Quebec. Alternatively, the opening 25 may be any circular or polygonal opening for a suitable anchor fixture to affix itself thereto and therein.

With reference to FIG. 1, an exemplary base 20 may be constructed of any suitable material capable of use for a particular need. The exemplary base 20 may be a substantially inverted U-shaped device when viewed in its major cross-section (i.e., where top surface 21a and/or engagement face 27 and/or rear face 29 may be seen interconnecting two substantially vertically descending legs 22 therefrom). Interconnected to an exemplary base 20 may be an exemplary jaw 30 having a latch 31 and a locking head 32 that are movable with respect to the base 20 within the space of an exemplary mouth 23 of the base 20 via pivot 36. An exemplary structure for an exemplary jaw 30 may be further illustrated in FIG. 1B.

Continuing with reference to FIG. 1, an exemplary mount 60 may be comprised of a body 61 with wings 62 extending perpendicularly from the thickness thereof. An exemplary mount 60 may also possess one or more coupling zones 63 to enable the mount 60 to be interconnected to an exemplary attachment surface (as in FIGS. 1A and 6-7). An exemplary mount 60 may also possess a foot surface 64 that contacts the attachment surface (not shown), upon mount 60 being coupled to the same. In an exemplary aspect of the disclosed inventions herein, an exemplary base 20 may create a robust joint between itself and the mount 20 via a combination of legs 22, the jaw 30, and the wings 62 of the mount 60. In a preferred embodiment, the upper-most surface of body 61 of mount 60 may be substantially flat, although a textured surface may be desirable for certain applications.

Referring to FIG. 1A, an exemplary base 20 may be shown in proximity to an exemplary mount 60 that has been coupled to a vehicle portion 100 at an attachment surface 103. An exemplary vehicle portion 100 may comprise a floor 101, a shelf 102, the attachment surface 103, and a recess 104, whereby the shelf 102 may be elevated above floor 101 while the recess 104 is below floor 101. In an exemplary embodiment, attachment surface 103 may be at a distance above floor 101 but below shelf 102. Alternatively, attachment surface 103 may be on the floor 101. Further alternatively, attachment surface 103 may be within the recess. And still further alternatively, attachment surface may be on shelf 102. In a preferred embodiment, attachment surface 103 is at a height above floor 101 but below shelf 102 so that an exemplary mount 60 may have the upper-most part of its body 61 flush with the upper-most surface of shelf 102. In another preferred embodiment, attachment surface 103 may be any surface on vehicle 100 that may allow for receipt of coupling mechanisms 40, such as screws, bolts, and other mechanical fasteners known to those skilled in the art, to couple mount 60 to vehicle 100. Depending on the particular shape of an exemplary mount 60, mount 60 may be able to couple to an attachment surface 103 that spans a plurality of different surfaces (e.g., floor 101, shelf 102, and/or recess 104). As may be understood based on the disclosures and illustrative embodiment of FIG. 1A, when an exemplary base 20 is not engaged to an exemplary mount 60 found on attachment surface 103, the mount 60 may remain affixed to vehicle 100, but its coupling thereto would allow for full use of the surrounding space to lay objects flush against each shelf 102. Consequently, when base 20 is not present, an exemplary mount 60 as shown in FIG. 1A may continue to make the portion of vehicle 100 useable as if mount 60 was not present due to its profile vis-à-vis the remainder of the surfaces 101, 102, 103, and/or 104 in vehicle 100.

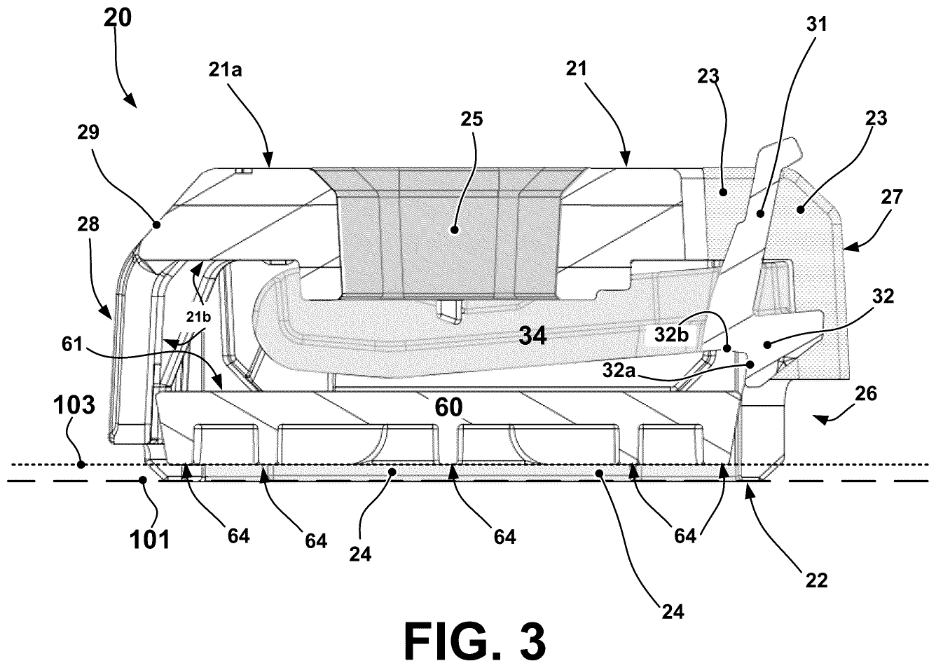

Referring to FIG. 1B, an exemplary base 20 may be illustrated in a deconstructed view to show the jaw 30 removed from its retention positions within base 20. As illustrated, an exemplary jaw 30 may comprise the latch 31 and lock 32 as previously described as well as the shoulder 33, arm 34, elbow 35, and pivot 36. In an exemplary embodiment, pivots 36 may couple to base 20 through accommodating apertures in the legs 22 of the exemplary base 20. The coupling between pivots 36 and base 20 may be free-rotating, spring biased, ratcheting, or any known form of resistance or intermittent adjustability known to those skilled in the art. As may be seen with respect to the arm 34 of the exemplary jaw 30, the arm 34 may be designed to traverse the interior space 31b (not shown, but illustrated in FIGS. 3-4 and 7) and maintain the lock 32 in whichever position is needed for the particular needs while also clearing the passage 26 of the exemplary base 20 and the received portions of the anchor fixture (not shown) when disposed through opening 25. In an exemplary embodiment, arm 34 may be biased toward the locked position by the shape of pivot 36 and/or the orifice for the pivot 36 in the base 20. As illustrated, both the pivot 36 and hole may be circular with a flat top section to prohibit free circular rotation. In other words, in this exemplary embodiment, pivot 36 may be a divided pin within a semi-circular hole in legs 22 of base 20 that will allow rotational movement a certain number of degrees until resistance is met in the rotation process (which may be maintained due to the spring-deformation of the slotted pin design of pivot 36 illustrated in the drawings but not otherwise limited thereto). Thus, in a preferred embodiment, the hole in legs 22 may mechanically bias arms 34 towards the locked and/or closed position (e.g., towards support surface 100) due to mechanically imposed limitations on the rotational freedom of pivot 36 within base 20. Those skilled in the art may contemplate additional ways to bias arms 34 of jaw 30 towards a closed configuration.

In another embodiment, an exemplary jaw 30 may have limitations on its ability to displace angularly based on the shapes of the elbow 35 or other geometry on the jaw 30. In one embodiment, an interior prong within an exemplary base 20 interior 31b may contact elbow 35 so that it cannot displace any further upwardly from a particular position. Further alternatively, where pivot 36 is spring-loaded or biased towards a position, the jaw 30 may be rotated against the spring bias by pushing latch 31 and thereby causing opposing deflection on such biased portions of the jaw. In an exemplary embodiment, each arm 34 on either side of the lock 32 of jaw 30 may form a substantially u-shaped structure.

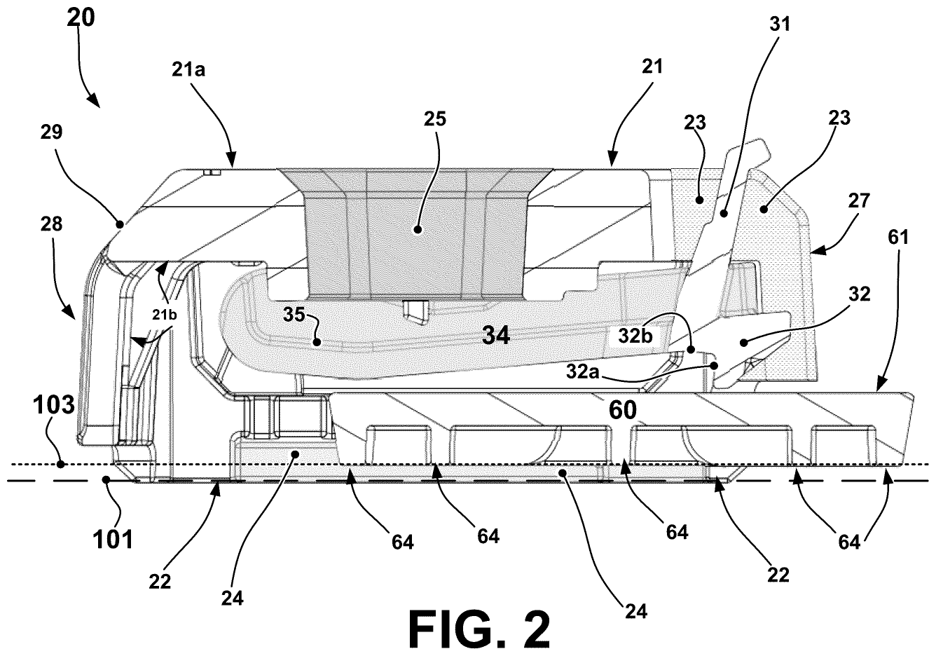

With reference to FIGS. 1B and 2, an exemplary base 20 may have rail 24 extending substantially away from each foot 22 making up the base 20. An exemplary rail 24 may be configured to slide under wings 62 of an exemplary mount 60 to allow for a tight interfere-type engagement between the two structures that allows for robust attachment between the base 20 and the mount 60 and the vehicle 100 with which the mount 60 may be coupled. In a preferred embodiment, an exemplary base 20 may be engaged with an exemplary mount 60 via the mating of wings 62 with rails 24 and the locked configuration of the jaw 30.

Referring to FIG. 1C, another exemplary embodiment of base 20 may be illustrated in a deconstructed view to show the jaw 30 removed from its retention positions within base 20. As illustrated, an exemplary jaw 30 may comprise the latch 31 and lock 32 as previously described as well as the shoulder 33, arm 34, elbow 35, and a pivot 37 with a laterally angled face 37a. According to this exemplary embodiment, when the pivot 37 makes contact with an exemplary mount 60, it may be urged outwardly and through the aperture 22A in base 20. In an exemplary aspect of this embodiment, the laterally angled face 37a may ensure that the pivot 37 is pushed further outward to avoid inadvertent disengagement with the base 20. In an exemplary aspect, which may be illustratively shown via FIGS. 1C and 1D, an exemplary aperture 22A may contain an angled surface 22B (or be otherwise contoured) to further bias pivot 37a outwardly to resist any tendency of pivot 37 to dislodge from base 20 when a force is exerted against the engagement surface 27, jaw 30 portions 31-32, and/or other surfaces adjacent to the same. While an angled surface 37a has been shown, those skilled in the art may consider other resistance increasing arrangements such as tooth-and-recess connections, ball and socket, and other mechanically equivalent snap-fit or friction-fit arrangements. An illustrative embodiment of a jaw 30 with an angled pivot 37 frictionally received in an exemplary base 20 configured to hold the same in a biased configuration as previously described is provided in FIG. 1E.

With particular reference to the illustrative embodiments of FIGS. 2-4, an exemplary sliding engagement between an exemplary base 20 and an exemplary mount 60 may be shown. For example, in an exemplary sliding engagement illustrated in FIG. 2, an exemplary base 20 may receive through passage 26 the mount 60 located on its attachment surface 103. As may be depicted in FIG. 2, the foot 22 of an exemplary base 20 may be in contact with floor 101 of the vehicle 100. In an exemplary embodiment, as an exemplary mount 60 while coupled to attachment surface 103 is received within a base 20, the rails 24 of the exemplary base 20 may slide under the wings 62 of an exemplary mount 60 while the upper surface 61 of mount 60 causes the lock 32 to deflect radially upwardly away from the floor 101. As a result, the arms 34 of jaw 30 may be radially deflected away from floor 101 as a result of the aforementioned deflection of lock 32.

As illustratively provided, a maximum radially deflection of jaw 30 about pivot point 36 may be reached during the exemplary sliding engagement step illustratively provided in FIG. 2, As illustrated, numerous structures within the internal cavity 21b of exemplary base 20 may act as stoppers or other deflection-resistant surfaces that preclude any further radially upward movement of the jaw 30. To the extent an exemplary base 20 may have a spring-loaded jaw 30, the spring may be located at a suitable junction point on a surface of cavity 21b and couple to a portion of jaw 30, such as, for example, elbow 35 and/or within a reception point in the shoulders 33 or arms 34. In an exemplary embodiment, an exemplary jaw 30 may have several springs disposed in cavities in portions of jaw 30 to enable the jaw 30 to be predisposed to a position radially away from top surface 21a.

With reference to FIG. 3, an exemplary base 20 may fully cover an exemplary mount 60 by allowing the mount 60 to enter through the passage 26 of the base 60 so that no portion of the surface 61 is overlapped by engagement surface 27, and be retained by a portion of each foot 22 of the base 20, i.e., the interior surface of cavity 21b and/or rails 24. As was the case in FIG. 2, an exemplary jaw 30 may be deflected radially away from the floor 101 while the latch 31 of the jaw 30 may also radially deflect within the boundary created by mouth 23 of the base 20. In an exemplary embodiment, a joint between base 20 and mount 60 formed due to sliding engagement of rails 24 and wings 62 may be robust for anchoring of accessories to a vehicle 100.

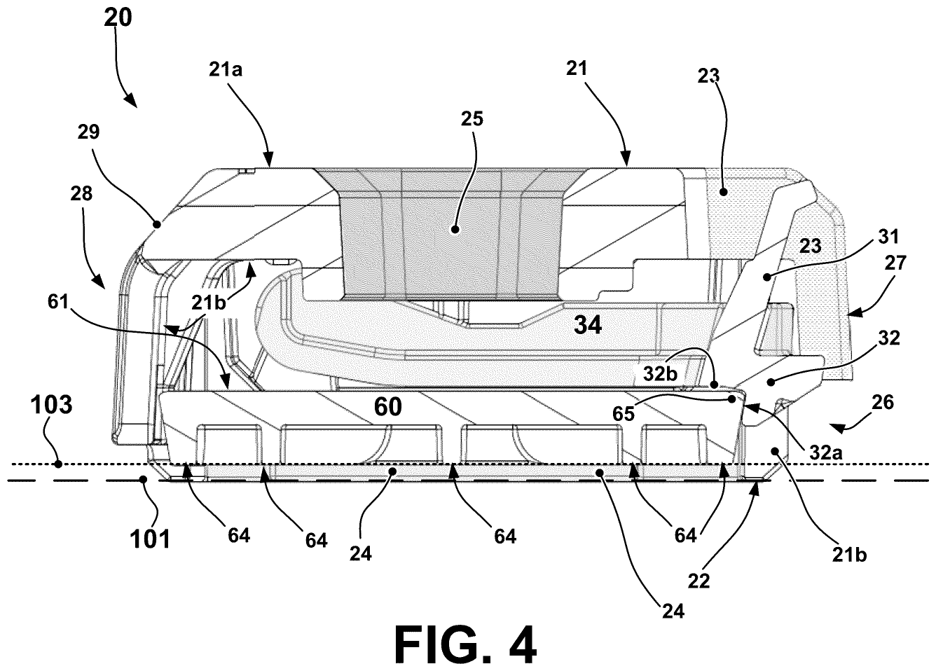

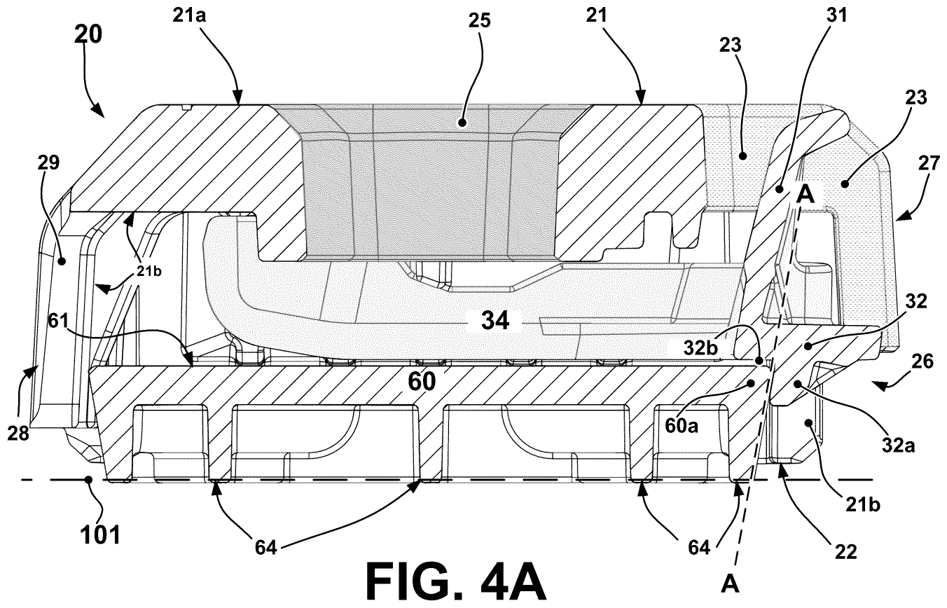

Referring to FIG. 4, an exemplary base 20 may be anchored to mount 60 by a combination of the sliding engagement of rails 24 and wings 62 and the locked configuration of lock 32 caused by tooth 32a and tongue 32b. In an exemplary embodiment, an exemplar jaw 30 may pivot into the locked configuration about mount 60 as illustratively provided in FIG. 4 by gravity or other mechanical means (e.g., resistance walls in the rotation of pivot 36, springs, ratcheting, or magnetism). In an exemplary locked configuration, an exemplary tongue 32b of lock 32 of jaw 30 may rest or remain in close proximity to surface 61 of the mount 60. In an exemplary locked configuration, an exemplary tooth 32a may rest against or otherwise hook into a resistance-fit or frictional contact with key face 65 of mount 60. While key face 65 may be shaped as having an acute cross section, key face 65 may be any number of shapes, contoured surfaces, and geometries to enhance the locking capability of jaw 30 with respect to mount 60. Additional key faces 65 may exist elsewhere along mount 60 to allow other structures on jaw 30 to engage therewith and enhance the robustness of an exemplary locking connection between base 20 and mount 60.

Similar to the embodiment described with respect to FIG. 4, the illustrative embodiment of FIG. 4A may provide another exemplary base 20 that may be anchored to a mount 60. However, according to FIG. 4A, the tooth 32a of jaw 30 is at an acute angle with respect to the surface of tongue 32b so that a plane A-A along which tooth 32a and mount surface 60a contact enables the frictional engagement between the two structures. As illustrated, the angle of plane A-A is such that the tooth 32a is pointed towards the rear of base 20 (e.g., in the direction from tooth 32a towards rear passage 28). In an exemplary embodiment, the acute angle between plane A-A and the reference line 101 depicted in FIG. 4A may be any angle between 80 degrees and 65 degrees, and preferably, at about 75 degrees.

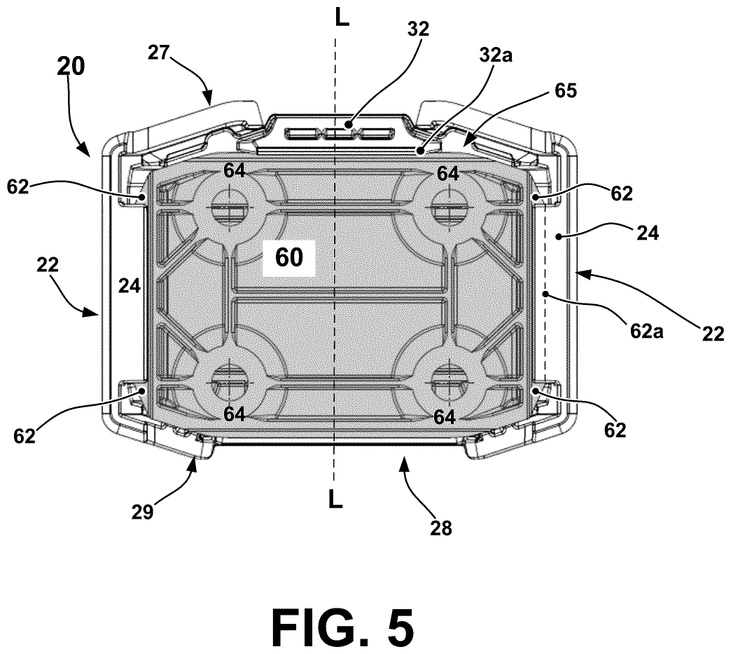

With reference to FIG. 5, an exemplary base 20 and mount 60 may be viewed from the frame of reference of the attachment surface 103 (i.e., underneath mount 60) to further illustrate the locking configuration when base 20 may be coupled to mount 60. As illustrated in FIG. 5, an exemplary base 20 may be shown with rails 24 extending inwardly towards the base 20 centerline “L”. Exemplary rails 24 may span only a portion of the distance between engagement surface 27 and rear surface 29 or may connect to rear surface 29. As may also be illustrated is an overlap of tooth 30a and key face 65 of mount 60 from underneath jaw 30. An exemplary wing line 62a may provide an illustrative location of the remainder of wing 62 when engaged with base 20. An exemplary wing line 62a may appear straight, but may be other configurations to enhance the robustness of connection between an exemplary base 20 and mount 60.

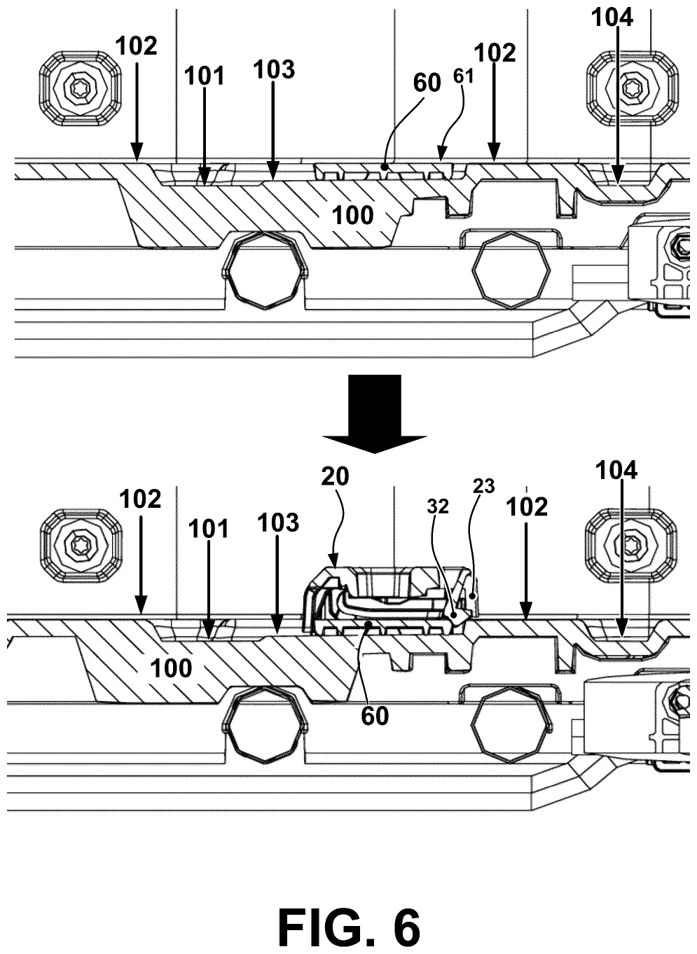

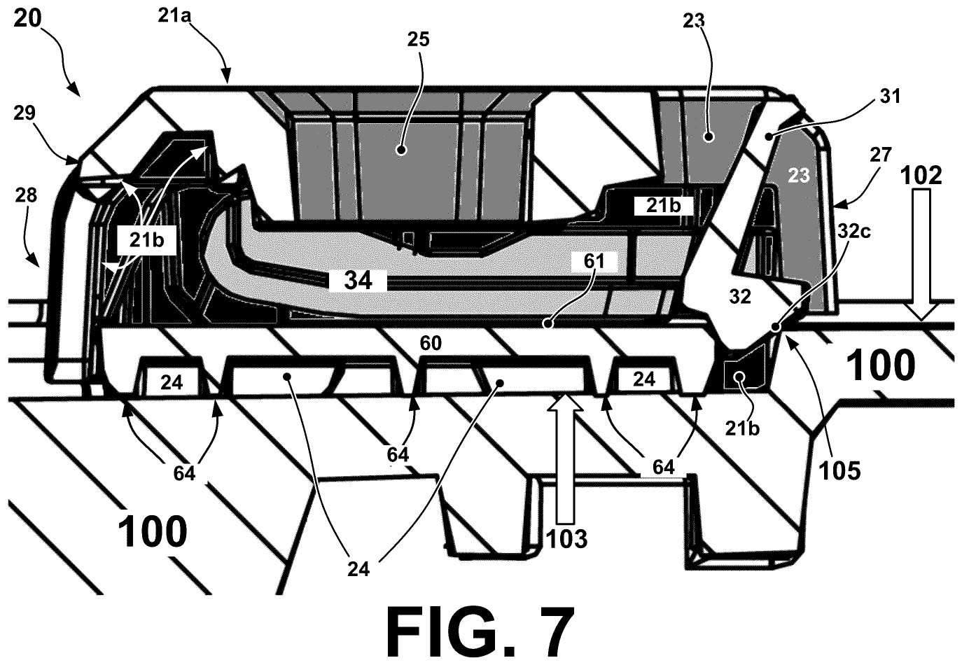

Referring to FIGS. 6-7, an exemplary vehicle portion 100, such as an ATV, personal watercraft, boat, motorcycle, or snowmobile may illustratively show an exemplary mount 60 when coupled to the vehicle portion 100. In an exemplary coupling arrangement, an exemplary mount 60 may have an upper surface 61 that is substantially flush with the surface of shelf 102. In one embodiment, mount 60 may be coupled to vehicle 100 so that its upper-most extent does not otherwise deviate the surfaces of other support surfaces found on vehicle 100, such as, for example, shelf 102. In another embodiment, mount 60 may be coupled to vehicle portion 100 so that it provides a vertical extent that is substantially the same as any other surfaces of the vehicle portion 100, e.g., floor 100 or shelf 102. For example, an exemplary mount 60 may be coupled within a recess 104 so that its upper surface 61 may be at the same level and/or flush with floor 101. As another example, an exemplary mount 60 may be coupled to attachment surface 103 so that its upper surface 61 may be at the same level and/or flush with shelf 102. As yet another example, an exemplary mount 60 may be coupled to floor 101 so that its upper surface 61 may be the same level and/or flush with shelf 102. In yet another alternative example, an exemplary mount 60 may be coupled to floor 101 so that its upper surface 61 may be the same level and/or flush with an attachment surface 103, while that attachment surface 103 may be the coupling surface for another exemplary mount 60, whose upper surface 61 will be at the same level and/or flush with a shelf 102 also formed in the vehicle portion 100.

As further depicted in FIGS. 6-7, upon engaging an exemplary mount 60 mounted to an attachment surface 103, an exemplary base 20 may have at least some portion that overlaps the attachment surface 103, e.g. lock 32, and at least another portion that overlaps the shelf 102, e.g., mouth 23. When an exemplary base 20 is engaged to an exemplary mount 60, there may be a plurality of exemplary base 20 portions that may overlap a plurality of exemplary surfaces 101, 102, 103, 104 found on an exemplary vehicle portion 100. As also illustrated in FIGS. 6-7, an exemplary lock 32 of an exemplary jaw 30 of an exemplary base 20 may also be frictionally pressed by a zone 105 of the adjacent shelf 102 at a compression point 32c.

Each of base 20, mount 60, and jaw 30 may be made of any known materials depending on the needs of the user. For example, an exemplary base 20 and mount 60 may be a machined aluminum component while jaw 30 may be a plastic component. Alternatively, base 20 may be a hybrid construct of rubber attached to metal (e.g. aluminum), while jaw 30 may be metal or plastic, and mount 60 a metal. Further alternatively, base 20 may be a thermoplastic, mount 60 a metal, and jaw 30 another type of thermoplastic. In any and all permutations of material selection for the exemplary constructs discussed herein, those skilled in the art may choose appropriate materials to allow these constructs 20, 60, 30 to survive the loads, forces, and torques that may be sustained in use on a recreational vehicle on rough terrain.

Many further variations and modifications may suggest themselves to those skilled in art upon referring to the above disclosure and foregoing interrelated and interchangeable illustrative embodiments, which are given by way of example only, and are not intended to limit the scope and spirit of the interrelated embodiments of the invention described herein.

1. An anchor attachment device, comprising:
a body having a top surface interconnecting a pair of legs and a cavity therein, the body having an opening through a thickness between the top surface and the cavity and a passage between the pair of legs and through the cavity, the passage being substantially orthogonal to the opening; and
a u-shaped jaw rotatably coupled to the body within the cavity, wherein the jaw comprises an arm on either side of a lock, wherein the lock comprises at least one tooth structure descending away from the arm of the jaw.

2. The anchor attachment device of claim 1, further comprising a mouth formed in the body within which the lock may radially displace outside of the body.

3. The anchor attachment device of claim 1, further comprising a latch extending upwardly from the lock.

4. The anchor attachment device of claim 3, wherein the latch and the lock are configured to radially displace within a mouth formed in the body.

5. The anchor attachment device of claim 1, further comprising a rail extending from each of the pair of legs below each arm of the jaw.

6. The anchor attachment device of claim 1, wherein the opening has a shape configured to outwardly bias a pivot of the jaw with respect to the body.

7. The anchor attachment device of claim 1, wherein the at least one tooth structure descends downwardly and away from the opening.

8. The anchor attachment device of claim 1, further comprising a rail extending perpendicularly away from each of the pair of legs.

9. The anchor attachment device of claim 8, wherein each arm of the jaw is substantially parallel to each rail above which it is located.

10. The anchor attachment device of claim 1, further comprising a separable mount located within the cavity of the body.

11. The anchor attachment device of claim 10, further comprising a rail extending from each of the pair of legs below each arm of the jaw and in sliding connection with a portion of the separable mount.

12. The anchor attachment device of claim 11, wherein the jaw is radially deflected away from the separable mount.

13. The anchor attachment device of claim 10, further comprising a latch extending upwardly from the lock.

14. The anchor attachment device of claim 13, wherein the latch and the lock are configured to radially displace within a mouth formed in the body.

15. The anchor attachment device of claim 14, wherein the latch and the lock are radially deflected away from the separable mount into the mouth.

16. The anchor attachment device of claim 10, wherein the opening is located above the separable mount.

17. The anchor attachment device of claim 16, further comprising an anchor coupled to the body and the mount via the opening.

18. The anchor attachment device of claim 10, wherein the mount is coupled to a vehicle.

19. An anchor attachment system, comprising:
a body having a top surface interconnecting a pair of legs and a cavity therein, the body having an opening through a thickness between the top surface and the cavity and a passage between the pair of legs and through the cavity, the passage being substantially orthogonal to the opening;
a u-shaped jaw rotatably coupled to the body within the cavity, wherein the jaw comprises an arm on either side of a lock, wherein the lock comprises at least one tooth structure; and
a separable mount that is configured to engage the body and be rigidly coupled to the body via the at least one tooth.

20. The anchor attachment system of claim 19, further comprising a vehicle to which the separable mount is coupled.
